(19) United States
(12) Patent Application Publication
(10) Pub. No.: US 2019/0270109 A1
(43) Pub. Date: Sep. 5, 2019

(54) PRESSING DEVICE FOR LIQUID FOOD CONTAINER

(71) Applicant: HORNG CHANG METAL INDUSTRIAL CO., LTD., Tainan (TW)

(72) Inventors: PO-HSIN LEE, TAINAN CITY (TW); TSUNG-HUI CHEN, TAINAN CITY (TW)

(21) Appl. No.: 16/284,170

(22) Filed: Feb. 25, 2019

Related U.S. Application Data
(62) Division of application No. 15/910,319, filed on Mar. 2, 2018.

(51) Int. Cl. B05B 11/00; F04B 53/10; F04B 23/02

(52) U.S. Cl. CPC B05B 11/3019; F04B 23/023; F04B 53/10; B05B 11/3015

(57) ABSTRACT

This invention relates to a pressing device of a liquid food container, and the pressing device is mounted on the container's cover. The pressing device includes a pressing head which is connected to drive a compression part, so that the compression part can drive a first and second anti-leak valves in pressing and releasing actions. The valve heads of the anti-leak valves are alternatively closed and opened under the pressing and releasing actions. Thus, the liquid in the container can be stored in the liquid storage chamber through a liquid suction port, and then extruded out from a liquid outlet through the liquid conduction port. Therefore, the use of the anti-leak valves can effectively and accurately control the liquid out of the liquid's volume and the internal vacuum state, the liquid is locked in the pressing device without dripping in a vacuum state to achieve leak-proof and anti-splash effect.

### RELATED APPLICATION

This application is a Divisional patent application of co-pending application Ser. No. 15/910,319, filed on 2 Mar. 2018, now pending. The entire disclosure of the prior application, Ser. No. 15/910,319 is considered a part of the disclosure of the accompanying Divisional application and is hereby incorporated by reference.

### BACKGROUND

### Field of Invention

The invention relates to a pressing device of a liquid food container, in particular to a pressing device used as a metered liquid for food in the diet.

### Description of Related Art

People often use pressing device to draw a variety of liquid in containers. Because of the pressing device has the advantages of easy operation and fixed outflow, etc., the pressing device is widely used in the liquid container pumping. The liquid container and its pressing device cover a wide range of applications.

But here, especially a pressing device used in food category is described. In the diet industry, no matter cooking, seasoning (such as syrup or wine . . . etc.), adding various kinds of ingredients (such as concentrated fruit juice . . . etc.) or condiments need to be precise, since a little less than a minute will make delicious lost. Therefore, the pressing device of a container is more stringent checks. For example, a food pump, disclosed in patent U.S. Pat. No. 5,375,746, two ball valves are disposed in the valve body mainly. In the process of pressing, the two valve balls respectively correspond to the opening or closing of an outlet and an inlet under a pressure to form a structure of a pressing pump. However, since the balls are freely rolling in the ball rooms, it cannot be sure that the outlet and the inlet can be completely blocked. If the balls are not a true sphere, it is difficult for the outlet and the inlet to be completely sealed. Because of this, it is easy to make the interior not vacuum, so that the liquid leaks from the pipelines and thus is splashed around or even splashed back to the nozzle. This makes the user headache. As the pressing device is used widely, a pressing device with features of improved operability and preventing liquid from remaining on the nozzle is an important issue for the people involved in the industry.

### SUMMARY

The main purpose of the present invention is to provide a pressing device for a liquid food container, in particular to a pressing device for regulating the edible liquid used in the diet, in order to locking the liquid in the vacuum tube for the purpose of no dripping.

The main purpose and effect of the pressing device of a liquid food container of the present invention are achieved by the following specific technical means.

The pressing device comprises a pressing head which is connected to drive a compression part, so that the compression part can drive the first and the second anti-leak valves in pressing and releasing actions. The valve heads of the anti-leak valves are alternatively closed and opened under the pressing and releasing actions. Thus, the liquid in the container can be stored in the liquid storage chamber through the liquid suction port, and then extruded out from the liquid outlet through the liquid conduction port. Therefore, the use of the anti-leak valves can effectively and accurately control the liquid out of the liquid's volume and the internal vacuum state, the liquid is locked in the pressing device without dripping in a vacuum state to achieve leak-proof and anti-splash effect.

In the pressing device of a liquid food container according to an embodiment of this invention, the first anti-leak valve is correspondingly mounted on the liquid suction port, wherein the first anti-leak valve comprises a first fixing seat, a movably displaced first valve rod is embedded in the first fixing seat, one end of the first valve rod forms a first valve head, a first elastic member is sleeved on the first valve rod, the first elastic member is located between the first fixing seat and the first valve head, the first valve head can seal the liquid suction port or be separated from the liquid suction port.

In the pressing device of a liquid food container according to an embodiment of this invention, the second anti-leak valve is correspondingly mounted on the liquid-conducting port, wherein the second anti-leak valve comprises a second fixing seat, a movably displaced second valve rod is embedded in the second fixing seat, one end of the second valve rod forms a second valve head, a second elastic member is sleeved on the second valve rod, the second elastic member is located between the second fixing seat and the second valve head, the second valve head can seal the liquid-conducting port or be separated from the liquid-conducting port.

### BRIEF DESCRIPTION OF THE DRAWINGS

FIG. 1 is a three-dimensional exploded view of a first embodiment of the present invention.

FIG. 2 is an exploded perspective view of an anti-leak valve according to the first embodiment of the present invention.

FIG. 3 is a schematic view of the anti-leak valve assembly according to the first embodiment of the present invention.

FIG. 4 is an overall cross-sectional view of the first embodiment of the present invention.

FIG. 5 is a partial cross-sectional view of the first embodiment of the present invention.

FIG. 6 is a cross-sectional schematic diagram of the pressing downward operation according to the first embodiment of the present invention.

FIG. 7 is a cross-sectional view of the restoring operation according to the first embodiment of the present invention.

FIG. 8 is an overall cross-sectional view of a second embodiment of the present invention

FIG. 9 is a cross-sectional schematic diagram of the pressing downward operation according to the second embodiment of the present invention.

FIG. 10 is a cross-sectional view of the restoring operation according to the second embodiment of the present invention.

FIG. 11 is a schematic diagram of the upper and lower positioning members of the present invention.

### DETAILED DESCRIPTION

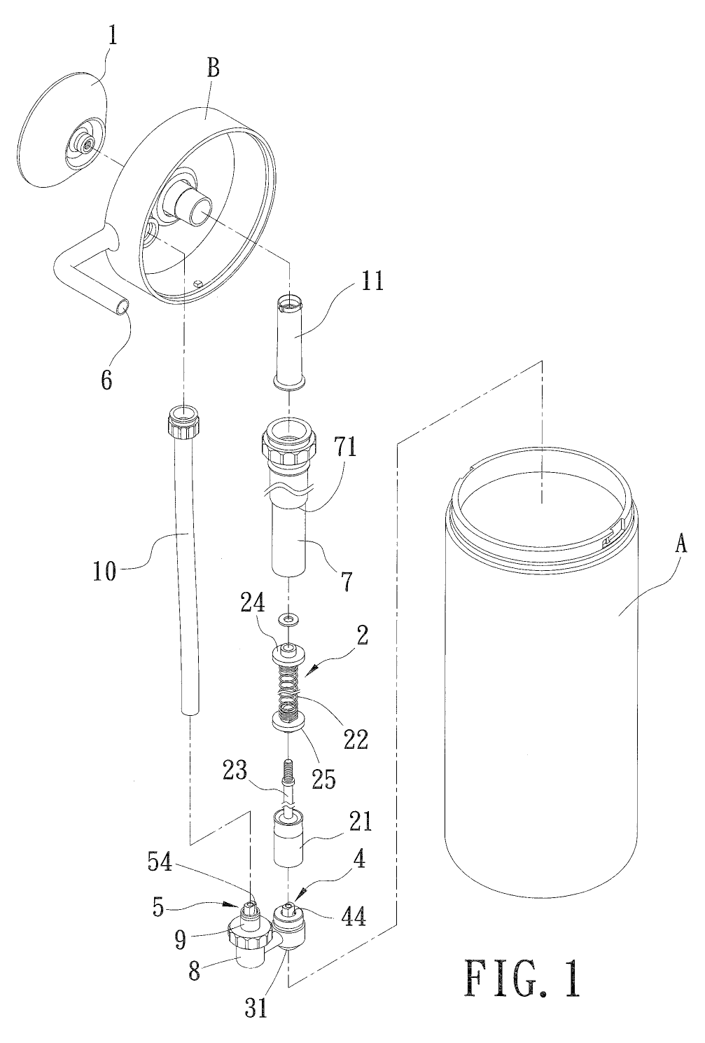

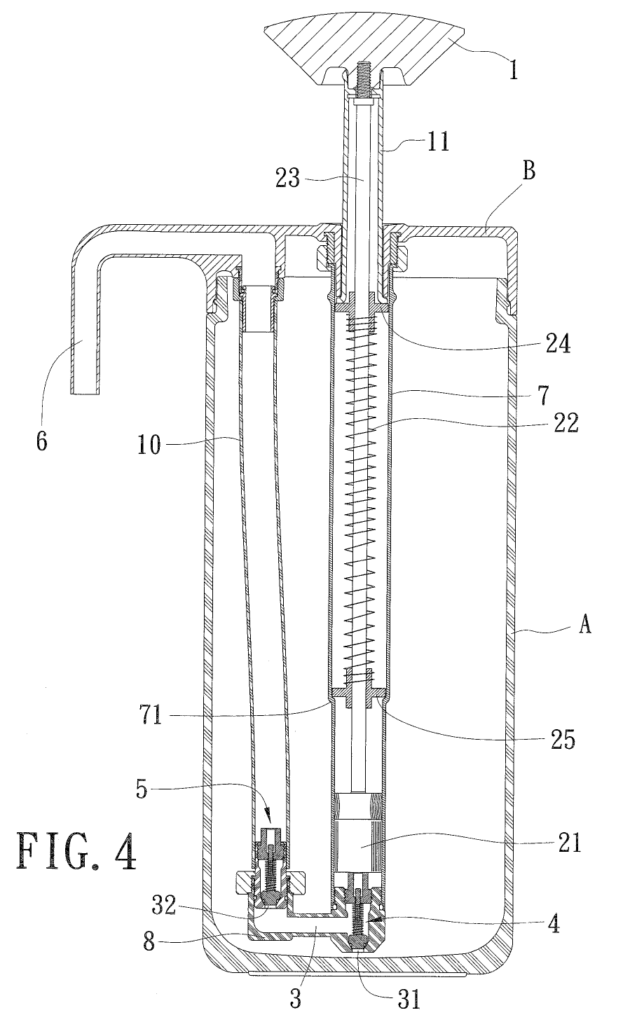

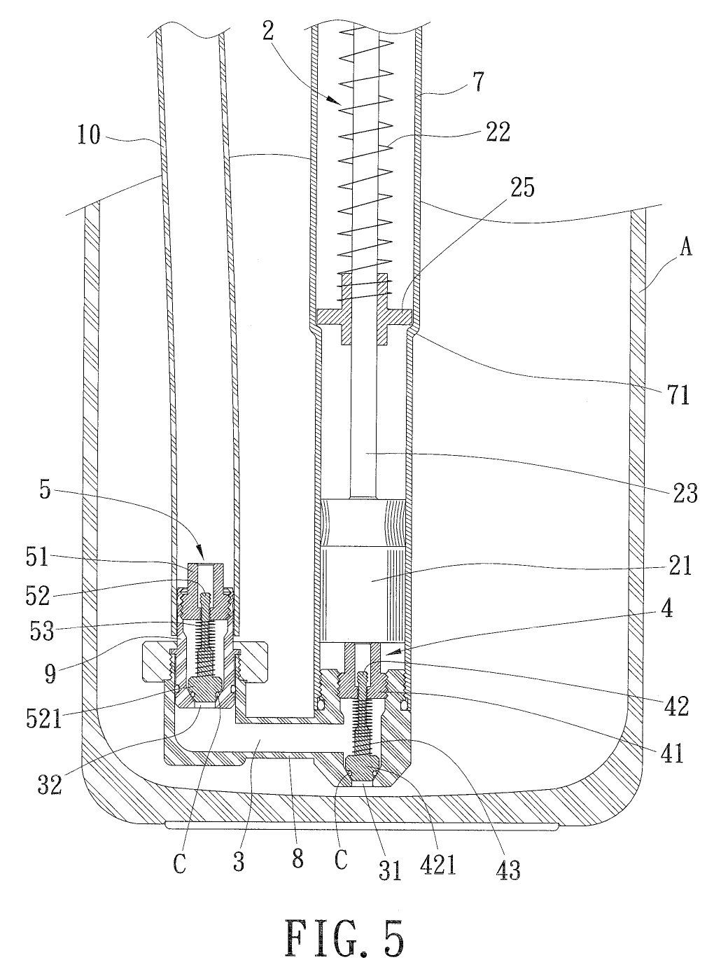

First, please refer to FIGS. 1 and 4-5. A pressing device is installed on a cover B of a container A. The pressing device comprises a pressing head 1, a compression part 2, a liquid storing chamber 3, a first anti-leak valve 4, a second anti-leak valve 5, and a liquid outlet 6.

The pressing head 1 is movable set on the cover B and to be pressed by a user, so that the pressing head 1 is moved relative to the cover B to activate the liquid outlet.

The compression part 2 is correspondingly assembled at one end of the pressing head 1, and a piston 21 and a main elastic part 22. So that the compression part 2 can be driven by the pressing head 1 to allow the main elastic part 22 to exhibit a compressed-releases action and drive the piston 21 to displace.

The liquid storing chamber 3 is disposed inside the pressing device and is provided with a liquid suction port 31 and a liquid-conducting port 32 at both ends thereof. The first anti-leak valve 4 is correspondingly mounted on the liquid suction port 31, wherein the first anti-leak valve 4 includes a first fixing seat 41. A first valve rod 42, which can be movably displaced, is embedded on the first fixing seat 41. A first elastic member 43 is sleeved on the first valve rod 42 and located between the first fixing base 41 and a first valve head 421. The first valve head 421 can correspondingly seal the liquid suction port 31 or be separated from the liquid suction port 31. The second anti-leak valve 5 is correspondingly mounted on the liquid-conducting port 32 and has a second fixing seat 51. A second valve rod 52 is movably embedded in the second fixing seat 51. The end of the second valve rod 52 forms a second valve head 521. A second elastic member 53 is sleeved on the second valve rod 52 and located between the second fixing seat 51 and the second valve head 521. The second valve head 521 can correspondingly seal the liquid-conducting port 32 or be separated from the liquid-conducting port 32.

The liquid outlet 6 is connected to the second anti-leak valve 5 and communicates with the liquid-conducting port 32. The liquid outlet 6 is used to export the liquid inside the container A. When actually implemented, the pressing device of a liquid food container in this invention is mainly used for various fields, such as adding a sugar solution into drinks, concentrates, adjusting wine's dosage for cocktail, and so on, which can extract out the liquid in the container, and the liquid may be contained in different types of containers. Below are some examples.

### Example 1

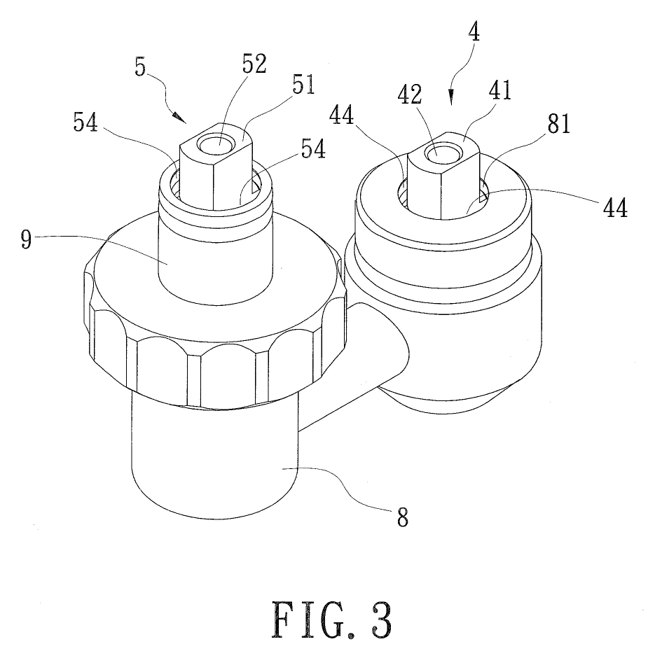

Please refer to FIGS. 1-7. The pressing head 1 is provided with a rod portion 11 penetrating the cover B. One end of the rod portion 11 is correspondingly embedded in an outer tube 7, and one end of the outer tube 7 is locked to the cover B. The compression part 2 is correspondingly assembled inside the outer tube 7. The piston 21 of the compression part 2 is provided with an actuating rod 23. One end of the actuating rod 23 is locked to the pressing head 1, and the actuating rod 23 is provided with an upper positioning member 24 and a lower positioning member 25. A main elastic member 22 is sleeved outside the actuating rod 23 and located between the upper positioning member 24 and the lower positioning member 25. The other end of the outer tube 7 locks a connecting seat 8. The liquid storing chamber 3 is disposed in the connecting seat 8. The connecting seat 8 has a first opening 81 corresponding to the first fixing seat 41 of the first anti-leak valve 4. A first passage 44 between the first fixing seat 41 and the first opening 81 communicates with the liquid storing chamber 3. The liquid suction port 31 is disposed at the other end of the connecting seat 8 opposite to the first opening 81. The connecting seat 8 has a second opening 82 corresponding to a locking seat 9. The liquid-conducting port 32 is disposed on the locking seat 9 and correspondingly communicates with the liquid storing chamber 3. The locking seat 9 is correspondingly assembled with the second fixing seat 51 of the second anti-leak valve 5, and the second valve head 521 corresponds to the liquid-conducting port 32 on the locking seat 9. A second passage 54 between the second fixing seat 51 and the second opening 82 communicates with the liquid outlet 6. The liquid outlet 6 is disposed on one side of the cover B, and a hose 10 is sleeved on an outside of the locking seat 9. The hose 10 is connected and conducted to the liquid outlet 6.

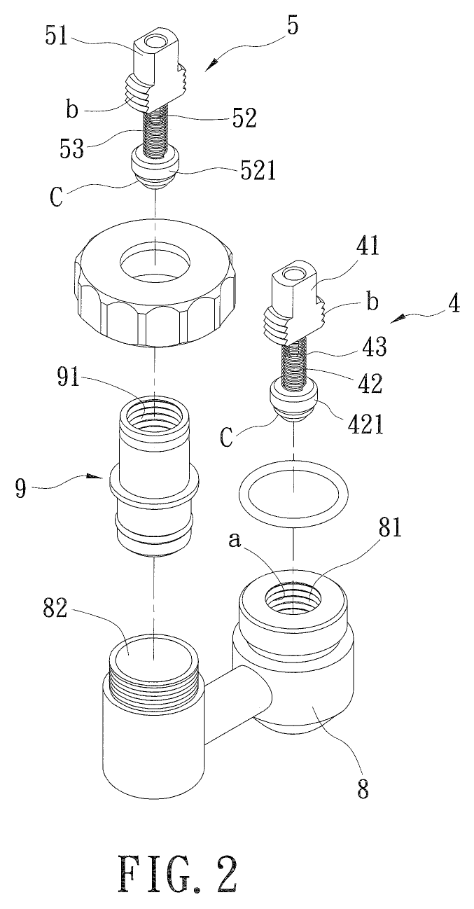

The structures of the first anti-leak valve 4 and the second anti-leak valve 5 are substantially the same, and the difference is that the assembly positions are different. Please refer to FIGS. 2-3 and 6-7. An inner thread portion a is disposed on an inner diameter of the first opening 81 of the connecting seat 8. The first fixing seat 41 is a seat body with a flattened surface on both sides thereof, and an outer thread portion b is disposed on an outside of the first fixing seat 41. When the first fixing seat 41 is locked to the inner diameter of the first opening 81, the first passage 44 between the first fixing seat 41 and the first opening 81 can be connected to the liquid storing chamber 3. Similarly, an inner thread portion a is disposed on an inner diameter of an opening 91 of the locking seat 9, and the second fixing seat 51 is a seat body having a flattened surface on both sides thereof and, an outer thread portion b is disposed on an outside of the second fixing seat 51. When the second fixing seat 51 is locked to the inner diameter of the second opening 82, the second passage 54 between the second fixing seat 51 and the second opening 82 can be connected to the liquid outlet 6. Further, each of the first valve head 421 and the second valve head 521 is a conical seat that can closely seal the liquid suction port 31 and the liquid-conducting port 32 by using a conical design. Further, a washer C is respectively disposed outside the first valve head 421 and the second valve head 521 so as to allow the first valve head 421 and the second valve head 521 to communicate with the liquid suction port 31 and the liquid-conducting port 32 to achieve more sealing effect, so that it does not leak.

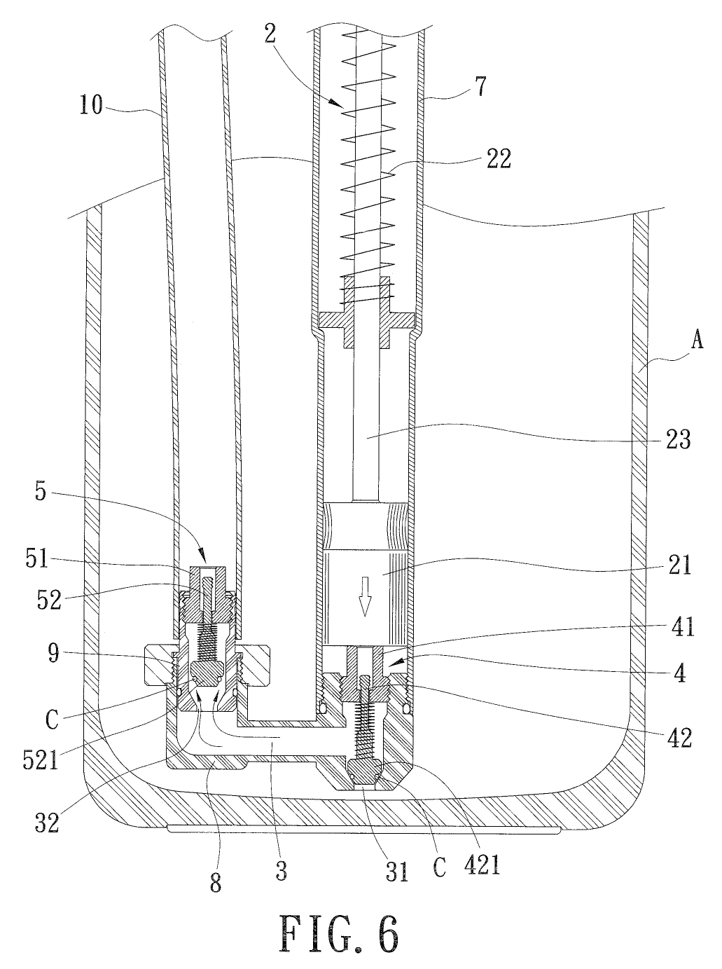

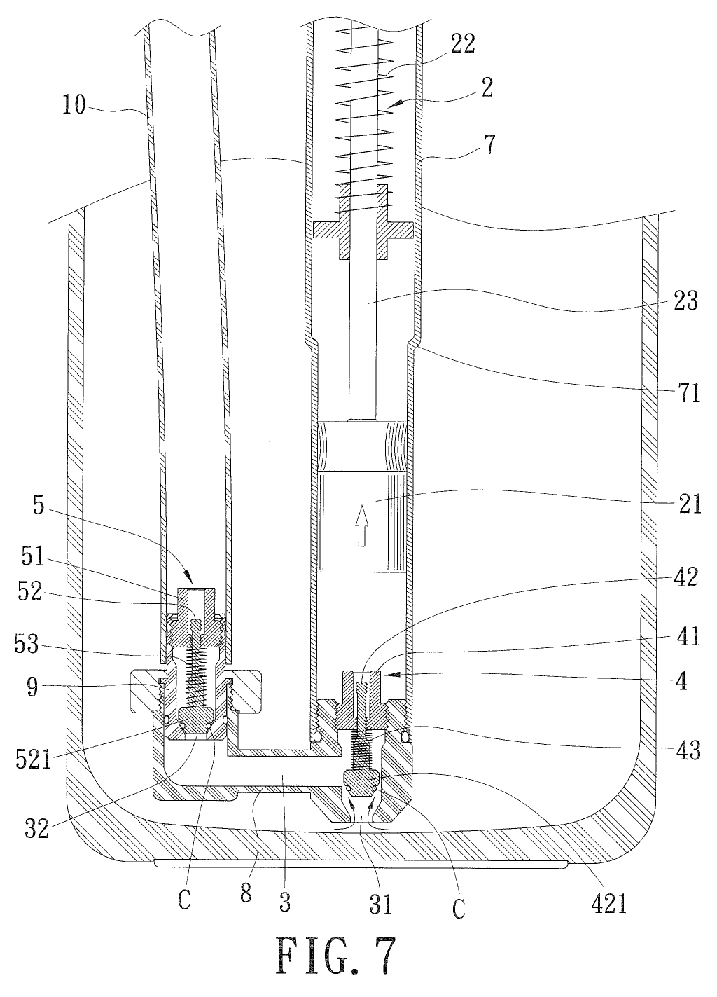

When the actual operation of the Example 1, see FIGS. 6-7. When the cover B initially covers the container A filled with the liquid, the internal space, such as the liquid storing chamber 3, in a vacuum state that can be filled with liquid by repeatedly pressing the pressing head 1. After the pressing head 1 is pressed down, the rod portion 11 drives the actuating rod 23 and the piston 21 to move in the outer tube 7. When the lower positioning member 25 abuts against a shrinking section 71 of the outer tube 7, the main elastic member 22 of the compression part 2 is squeezed. The piston 21 pushes the gas in the outer tube 7 through the first passage 44 and pushes the liquid in the liquid storing chamber 3 toward the second anti-leak valve 5. Simultaneously with the gas pushing of the liquid, the first valve head 421 of the first valve rod 42 of the first anti-leak valve 4 can also hermetically seal the liquid suction port 31 so that the liquid in the container A will not countercurrent to the liquid suction port 31. The liquid in the liquid storing chamber 3 displaces the second valve rod 52 of the second anti-leak valve 5 to compress the second elastic member 53 to disengage the second valve head 521 from the liquid-conducting port 32. Liquid is led out of the liquid outlet 6 through the second passage 54 and the hose 10 from the liquid-conducting port 32. On the contrary, after releasing the pressing head 1, the piston 21 is reset by the restore elastic force of the main elastic member 22 of the compression part 2. Under vacuum suction, the first valve rod 42 of the first anti-leak valve 4 is driven to move on the first fixing seat 41 through the first passage 44. The first elastic member 43 is compressed to disengage the first valve head 421 from the liquid suction port 31. At the same time as this action is performed, the reset attraction force attracts the second valve rod 52 of the second anti-leak valve 5 to shift back and allow the second valve head 521 to tightly seal the liquid-conducting port 32. At the same time, the liquid in the container A is sucked into the liquid storing chamber 3 from the liquid suction port 31 by the vacuum suction.

### Example 2

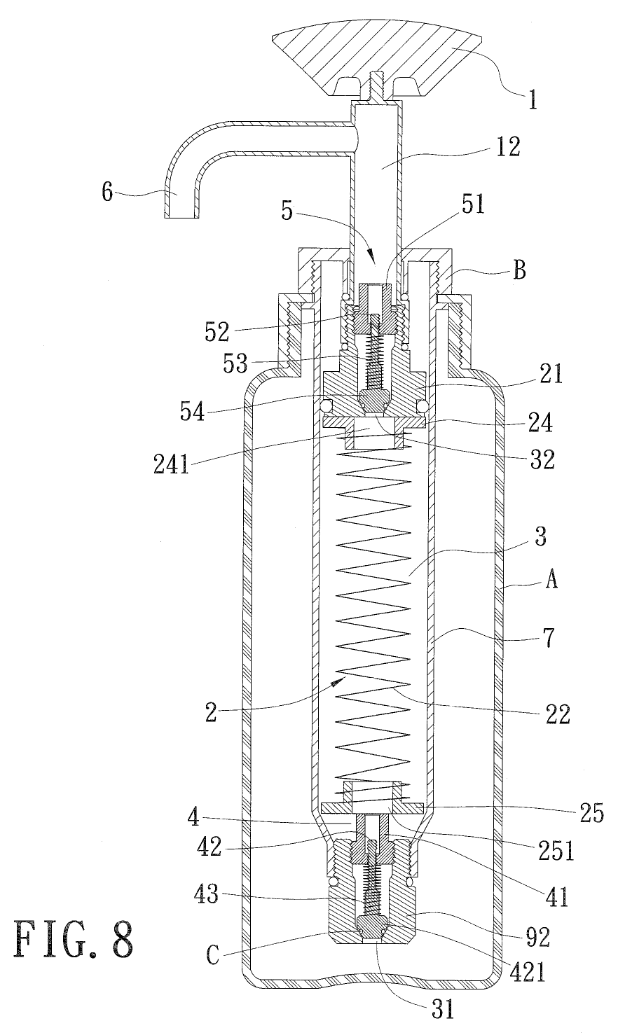

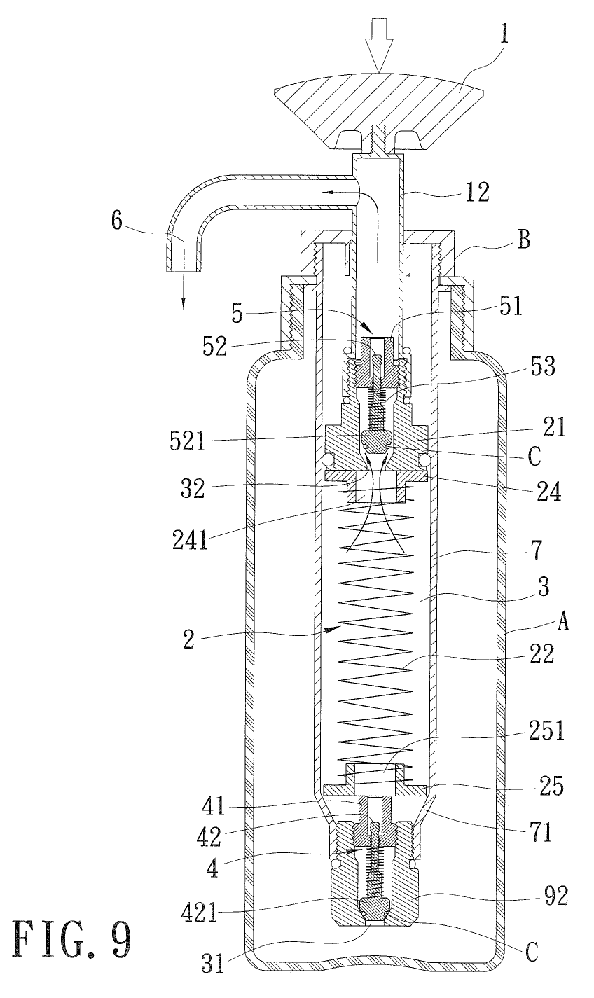

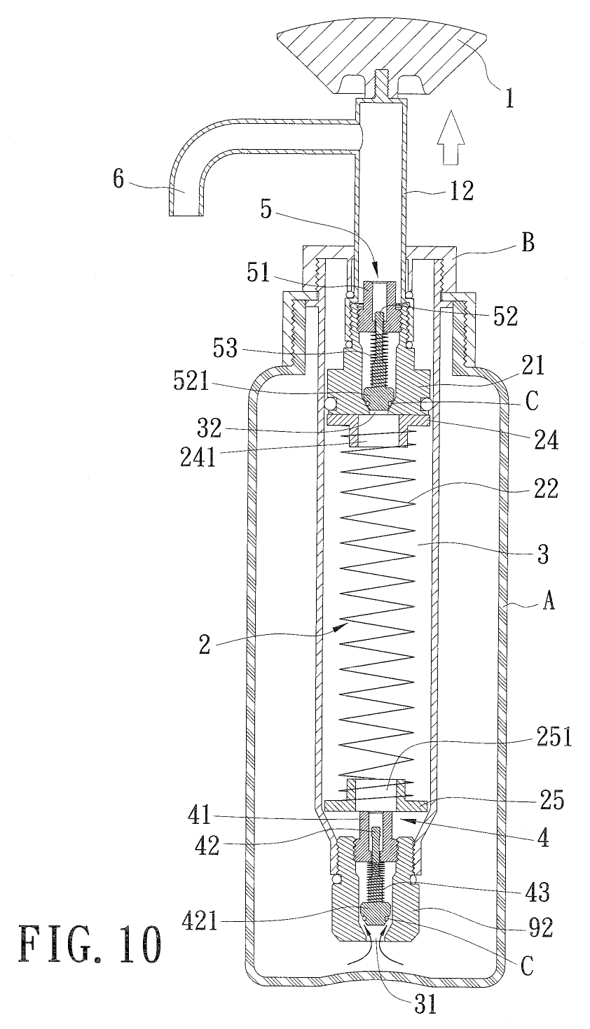

Please refer to FIGS. 8-10. The pressing head 1 is assembled on a hollow tube 12, one end of the hollow tube 12 penetrates the cover B and is correspondingly embedded in an outer tube 7, and one end of the outer tube 7 is locked to the cover B. And a liquid storing chamber 3 is formed in the outer tube 7. The end of the hollow tube 12 at the outer tube 7 corresponds to the piston 21 which locks the compression part 2. The liquid-conducting port 32 is disposed at a bottom of the piston 21. The second anti-leak valve 5 is installed inside the piston 21. The second fixing seat 51 is correspondingly disposed on an opening of the piston 21. The base of the outer tube 7 is correspondingly provided with a base 92. The liquid suction port 31 is disposed at a bottom of the base 92 and communicates with the interior of the container A. The first anti-leak valve 4 is mounted inside the base 92, so that the first fixing seat 41 is correspondingly disposed on the base 92. The upper positioning member 24 and the lower positioning member 25 are respectively disposed on both ends of the main elastic member 22. The upper positioning member 24 is located under the piston 21 and is provided with an upper perforation 241 corresponding to the liquid-conducting port 32. The lower positioning member 25 is located above the base 92 and has a lower through hole 251 corresponding to the liquid suction port 31. The liquid outlet 6 is disposed on the hollow tube 12 and communicates with the liquid-conducting port 32.

The structures of the first anti-leak valve 4 and the second anti-leak valve 5 are substantially the same, and the difference therebetween is the assembly locations are different. Please refer to FIGS. 8-10. An inner thread portion a is disposed on an inner diameter of an opening of the base 92, and the first fixing seat 41 is a base having a flattened surface on both sides, and an outer thread portion b is disposed on an outside of the first fixing seat 41. When the first fixing seat 41 is locked to the inner diameter of the opening, the first passage 44 between the first fixing seat 41 and the opening can be connected to the liquid storing chamber 3. Similarly, an inner thread portion a is provided on an inner diameter of the opening of the piston 21. The second fixing seat 51 is a seat body having a flattened surface on both sides, and an outer thread portion b is disposed on an outside of the second fixing seat 51. When the second fixing seat 51 is locked to the inner diameter of the opening, the second passage 54 between the second fixing seat 51 and the second opening 82 can be connected to the liquid outlet 6. The design of the valve head's shape is as Example 1.

When the actual operation in the Example 2, see FIGS. 8-10. When the cover B initially covers the container A filled with the liquid, the internal space, such as the liquid storing chamber 3, in a vacuum state that can be filled with liquid by repeatedly pressing the pressing head 1. After pressing down the pressing head 1, the hollow tube 12 drives the piston 21 to move in the outer tube 7. When the positioning is member 251 abuts against the shrinking section 71 of the outer tube 7, the main elastic member 22 of the compression part 2 is squeezed. The piston 21 pushes down the liquid in the liquid storing chamber 3 of the outer tube 7 to allow the first valve head 421 of the first anti-leak valve 4 to tightly seal the liquid suction port 31, so that the liquid in the container A will not flow towards the liquid suction port 31 and flow back to the liquid storing chamber 3. At the same time, the liquid in the liquid storing chamber 3 is pressed upward by the first anti-leak valve 4 at a bottom of the outer tube 7 to pass through the upper perforation 241 in the upper positioning member 24 and displace the second valve head 521 upward to compress the second elastic member 53. Liquid passes through the second passage 54 from the hollow tube 12 through the liquid outlet 6 to be led out. On the contrary, after the pressing head 1 is released, the piston 21 is reset by the restore elastic force of the main elastic member 22 of the compression part 2. Under vacuum suction, the first valve rod 42 of the first anti-leak valve 4 is driven by the first passage 44 to displace on the first fixing seat 41 and the first elastic member 43 is compressed to disengage the first valve head 421 from the liquid suction port 31. At the same time as this action is performed, the restoring gravity attracts the second valve rod 52 of the second anti-leak valve 5 to shift back and allow the second valve head 521 to tightly seal the liquid-conducting port 32.

the first valve rod 42 of the first anti-leak valve 4 is driven to move on the first fixing seat 41 through the first passage 44. The first elastic member 43 is compressed to disengage the first valve head 421 from the liquid suction port 31. At the same time as this action is performed, the reset attraction force attracts the second valve rod 52 of the second anti-leak valve 5 to shift back and allow the second valve head 521 to tightly seal the liquid-conducting port 32. At the same time, the liquid in the container A is sucked into the liquid storing chamber 3 from the liquid suction port 31 by the vacuum suction. Simultaneously, the liquid in the container A is drawn into the liquid storing chamber 3 from the liquid suction port 31 via the first passage 44 and the lower perforation 251 by the vacuum suction.

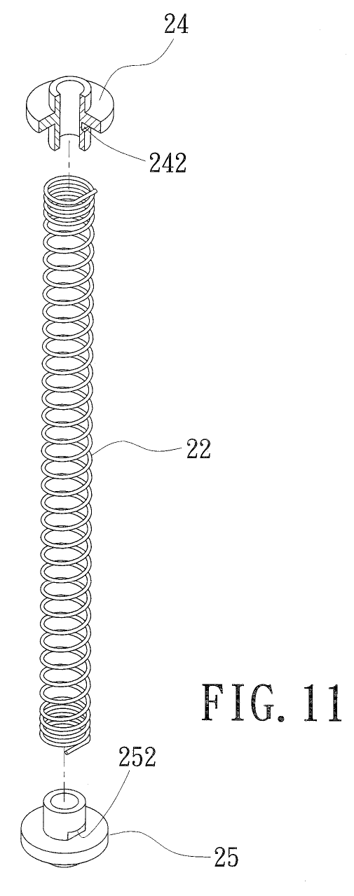

Please refer to FIG. 11. Further, notches 242 and 252 are disposed in the upper positioning member 24 and the lower positioning member 25 corresponding to the main elastic member 22, and the notches 242 and 252 are used to position the main elastic member 22.

The invention has the following advantages:

1. The present invention uses the design of the valve heads of the first and second anti-leak valves to completely seal the liquid suction port and the liquid-conducting port to prevent the liquid from flowing back. So that in the pressing and releasing process, the internal pipelines form a vacuum state without discoloration. This does improve the problem, that the traditional ball cannot tightly seal the outlet to have the dripping phenomenon, to effectively achieve the anti-drip effect.

2. As stated above, when the pipelines form a complete vacuum state, under no pressing action, the vacuum suction can be used to completely absorb the liquid in the pipelines. Even the container is shaken, there will be no liquid drip or spill to prevent splashing effect.

3. The main elastic member of the present invention can be adjusted by adjusting the thickness and length of the adjustable pressing device.

What is claimed is:

1. A pressing device of a liquid food container, wherein the pressing device is mainly installed on a cover of a container, the pressing device comprising a pressing head, a compression part, a liquid storing chamber, a first anti-leak valve, a second anti-leak valve, and a liquid outlet, wherein
the pressing head is installed on the cover, wherein the pressing head is a member pressed by a user to move relative to the cover to activate the liquid outlet;
the compression part is correspondingly assembled at one end of the pressing head and comprises a piston and a main elastic member, and the compression part can be driven via the pressing head to make the main elastic member show a contraction action and drive the piston to move;
the liquid storing chamber is disposed inside the pressing device and is provided with a liquid suction port and a liquid-conducting port on two ends of the liquid storing chamber;
the first anti-leak valve is correspondingly mounted on the liquid suction port, wherein the first anti-leak valve comprises a first fixing seat, a movably displaced first valve rod is embedded in the first fixing seat, one end of the first valve rod forms a first valve head, a first elastic member is sleeved on the first valve rod, the first elastic member is located between the first fixing seat and the first valve head, the first valve head can seal the liquid suction port or be separated from the liquid suction port;
the second anti-leak valve is correspondingly mounted on the liquid-conducting port, wherein the second anti-leak valve comprises a second fixing seat, a movably displaced second valve rod is embedded in the second fixing seat, one end of the second valve rod forms a second valve head, a second elastic member is sleeved on the second valve rod, the second elastic member is located between the second fixing seat and the second valve head, the second valve head can seal the to liquid-conducting port or be separated from the liquid-conducting por; and
the liquid outlet connects the second anti-leak valve and communicates with the liquid-conducting port, and the liquid outlet is used for guiding liquid inside the container to flow out.

2. The pressing device of claim 1, wherein the pressing head is assembled on a hollow tube, one end of the hollow tube penetrates the cover and is correspondingly embedded inside an outer tube, one end of the outer tube is locked to the cover, the outer tube forms a liquid storing chamber, the end of the hollow tube in the outer tube corresponds to a piston that locks the compression part, the liquid-conducting port is disposed at a bottom of the piston, the second anti-leak valve is installed inside the piston, and the second fixing seat is correspondingly arranged on an opening of the piston, a base is correspondingly disposed at a bottom of the outer tube, the liquid suction port is disposed on a bottom of the base and communicates with an inside of the container, the first anti-leak valve is installed inside the base, the first fixing seat is correspondingly arranged on an opening of the base, the main elastic member of the compression part is correspondingly installed in the liquid storing chamber of the outer tube, the upper and lower positioning members are separately arranged on both ends of the main elastic member, the upper positioning member is located under the piston and is provided with an upper perforation corresponding to the liquid-conducting port, the lower positioning member is located above the base and has a lower perforation corresponding to the liquid suction port, and the liquid outlet is disposed on the hollow tube and communicates with the liquid-conducting port.

3. The pressing device of claim 2, wherein an inner thread portion is formed in an inner diameter of the opening of the base, the first fixing seat is a seat body having flattened surfaces on two sides and an outer thread portion disposed on an outside of the first fixing seat, when the first fixing seat is locked to the inner diameter of the opening, the first passage between the first fixing seat and the opening can be connected to the liquid storing chamber.

4. The pressing device of claim 3, wherein an inner thread portion is formed in an inner diameter of the opening of the piston, the second fixing seat is a seat body having flattened surfaces on two sides and an outer thread portion disposed on an outside of the second fixing seat, when the second fixing seat is locked to the inner diameter of the opening, the second passage between the second fixing seat and the opening can be connected to the liquid outlet.

5. The pressing device of claim 4, wherein the first and second valve heads are conical heads, and a washer is respectively provided outside the first and second valve heads.

6. The pressing device of claim 5, wherein a shrinking section is arranged on the outer tube, and the shrinking section is used for receiving the lower positioning member.

7. The pressing device of claim 6, wherein notches for positioning the main elastic member are respectively disposed in the upper and lower positioning members for correspondingly embedding the main elastic member.
